(19) United States
(12) Patent Application Publication
(10) Pub. No.: US 2026/0309339 A1
(43) Pub. Date: Oct. 8, 2026

(54) ENERGY BUFFERING USING A HEAT PUMP

(71) Applicant: Mixergy Limited, Thame, Oxfordshire (GB)

(72) Inventor: Peter ARMSTRONG, Thame, Oxfordshire (GB)

(73) Assignee: Mixergy Limited, Thame, Oxfordshire (GB)

(21) Appl. No.: 19/481,550

(22) PCT Filed: May 3, 2024
(86) PCT No.: PCT/GB2024/051171

§ 371 Date: Nov. 5, 2025

(30) Foreign Application Priority Data
May 5, 2023 (GB) 2306683.0

(51) Int. Cl. F24D 3/08; F24D 3/18; F24D 18/00; F24D 101/40; F24D 103/17; F24H 15/156; F24H 15/225; F24H 15/238; F24H 15/277; F24H 15/296; F24H 15/305; F24H 15/375

(52) U.S. Cl. CPC F24D 3/08; F24D 3/18; F24D 18/00; F24H 15/156; F24H 15/225; F24H 15/238; F24H 15/277; F24H 15/296; F24H 15/305; F24H 15/375; F24D 2101/40; F24D 2103/17; F24D 2200/14; F24D 2220/042; F24D 2220/044; F24D 2240/26

(57) ABSTRACT

A heating system is provided. The heating system comprises a tank for holding fluid; a photovoltaic system; a heat pump arranged to provide heat to the tank; and a controller. The controller is configured to determine a quantity of heat stored in the tank relative to a target maximum quantity of heat that the heating system is adapted to store in the tank. The controller is configured to determine a level of solar power surplus electricity generated by the photovoltaic system. The controller is configured to change a power state of the heat pump on the basis of the quantity of heat stored in the tank relative to the target maximum quantity of heat that the heating system is able to store in the tank and the level of solar power surplus electricity.

The present invention relates to a heating system, and more particularly to a system that is capable of storing surplus energy using a heat pump.

### BACKGROUND

With increasing demands for lower energy consumption, heat pumps are displacing the use of gas boilers in many developed economies. Such systems are also used for air-conditioning applications in warmer regions or for commercial premises with high solar gain in cooler/temperate regions. Some systems cater to both cooling and space heating depending on the time of the year. There is usually a coupling of the hot water system to the heat pump with a hot water tank. It would be expensive and inefficient to build a heat-pump with the instantaneous heating capability required by domestic potable hot water applications such as power showers; it would also be very slow for hot water to be delivered from a cold start with a heat pump without any form of hot water storage.

Simultaneously, in many developed economies, electric power systems are migrating from a few large centralised power stations to many distributed generation systems such as roof-top solar photovoltaics. Photovoltaic (PV) systems are reliant on insolation for power production. The power output of PV typically varies and peak power output often does not correspond to peak demand. It is therefore desirable to provide an effective energy buffer for use in conjunction with PV systems.

### SUMMARY OF THE INVENTION

According to a first aspect there is provided a heating system comprising: a tank for holding fluid; a photovoltaic system; a heat pump arranged to provide heat to the tank; and a controller configured to: determine a quantity of heat stored in the tank relative to a target maximum quantity of heat that the heating system is adapted to store in the tank; determine a level of solar power surplus electricity generated by the photovoltaic system; and on the basis of the quantity of heat stored in the tank relative to the target maximum quantity of heat and the level of solar power surplus electricity, changing a power state of the heat pump.

By taking the quantity of heat stored in the tank relative to the target maximum quantity of heat that the heating system is adapted to store in the tank into account, excessive cycling of the heat pump can be prevented, leading to improved energy efficiency and reduced ageing of the heat pump.

The controller may be configured to switch on the heat pump on the condition of the quantity of heat stored in the tank relative to the target maximum quantity of heat exceeding a first threshold, preferably being at or below the first threshold. For instance the first threshold may be 75% or greater, preferably 80% or greater. For instance the first threshold may be 99% or smaller, preferably 95% or smaller. For instance the first threshold may be 85% or 90% or 95%. The first threshold may be selected in dependence on a tank volume and/or a heat pump power rating. This can permit the heat pump to be maintained in the on state for at least a minimum period of time. Preferably the quantity of heat stored in the tank relative to the target maximum quantity of heat is a ratio of the quantity of heat stored in the tank relative to the target maximum quantity of heat.

The controller may be configured to switch on the heat pump on the condition of the level of solar power surplus electricity exceeding a second threshold, preferably being above or at the second threshold. For instance the second threshold may be 50 watts or greater, preferably 100 watts or greater. For instance the second threshold may be 500 watts or smaller, preferably 200 watts or smaller. For instance the second threshold may be 75 watts, 100 watts, 150 watts, or 200 watts. The second threshold may be selected in dependence on a tank volume and/or a heat pump power rating.

The quantity of heat stored in the tank may be determined at least in part using one or more of:
a temperature probe;
a temperature sensor array comprising a plurality of temperature sensors;
a flow meter, for example at an inlet and/or outlet of the tank;
temperature sensors at an inlet and/or outlet of the tank; and
a temperature model of the tank.

The controller may be configured to determine additionally a length of time that would be required to raise the quantity of heat stored in the tank to the target maximum quantity of heat that the heating system is able to store in the tank. The controller may be configured only to change the power state of the heat pump when the length of time exceeds a minimum threshold. This can cause electricity generated by the photovoltaic system to be diverted to the heat pump rather than to satisfy other domestic electricity demands that may arise after the heat pump has been activated, in order to prevent short cycling at the heat pump.

The controller may determine the surplus electricity generated by the photovoltaic system as a difference between an electricity generated by the photovoltaic system and a domestic electricity demand. The controller may determine the surplus electricity generated by the photovoltaic system as an electricity being exported to an external electricity grid. The domestic electricity demand, the electricity generated by the photovoltaic system, and/or the electricity being exported to an external electricity grid may be determined by a current clamp. The domestic electricity demand, the electricity generated by the photovoltaic system, and/or the electricity being exported to an external electricity grid may be determined by a local utility meter. A predicted domestic electricity demand, a predicted electricity generated by the photovoltaic system, and/or a predicted electricity being exported to an external electricity grid may be determined by a model.

The controller may be configured only to change the power level of the heat pump when the surplus electricity generated by the photovoltaic system exceeds a minimum threshold. The minimum threshold may be 50 watts or greater, preferably 100 watts or greater. The minimum threshold may be 500 watts or smaller, preferably 200 watts or smaller. The minimum threshold may be 75 watts, 100 watts, 150 watts, or 200 watts. The minimum may be selected in dependence on a tank volume and/or a heat pump power rating.

The controller may be configured only to change the power state of the heat pump when the surplus electricity generated by the photovoltaic system exceeds a minimum threshold for a predetermined period of time. The predetermined period of time may be 5 seconds or less, or 10 seconds, or 15 seconds, or 20 seconds, or 30 seconds, or 45 seconds, or 60 seconds, or more. The predetermined period of time may be selected in dependence on a tank volume and/or a heat pump power rating.

The controller may be configured only to change the power state of the heat pump when a predicted surplus electricity generated by the photovoltaic system exceeds a minimum threshold.

The change in power state of the heat pump may be a binary change between an off state and an on state. The change in power state of the heat pump may modulate the power level between a lower power operating level and a higher power operating level.

The heating system may further comprise a user interface. The user interface may allow a user to configure changes in power state of the heat pump on the basis of external electricity prices.

The heating system may comprise one or more heat exchange means arranged to provide heat from the heat pump to the tank. The one or more heat exchange means may be one or more refrigerant coils, optionally internal to the tank; and/or one or more plate heat exchangers, optionally external to the tank.

The controller may be configured to reduce the power state of the heat pump if the surplus electricity generated by the photovoltaic system falls below a threshold. This can permit surplus electricity to be diverted to satisfy other domestic electricity demands that may arise after the heat pump has been activated, in order to prevent an overall electricity use exceeding the electricity generated by the photovoltaic system.

The controller may be configured to maintain the heat pump in the on state for at least a minimum period of time.

The controller may be configured to determine whether to provide heat to an upper part of the tank for topping up a smaller hot volume of water, or to provide heat to a lower part of the tank for gradually heating the whole tank; and to actuate a means of diverting heat either to an upper part of the tank or to a lower part of the tank.

According to another aspect there is provided a method of controlling a heating system, the method comprising: determining a quantity of heat stored in a tank relative to a target maximum quantity of heat that the heating system is able to store in the tank; determining a level of solar power surplus electricity generated by a photovoltaic system; and on the basis of the quantity of heat stored in the tank relative to the target maximum quantity of heat that the heating system is able to store in the tank and the level of solar power surplus electricity, changing a power state of the heat pump.

The method may comprise switching on the heat pump on the condition of the quantity of heat stored in the tank relative to the target maximum quantity of heat being at or below a first threshold. The method may comprise switching on the heat pump on the condition of the level of solar power surplus electricity being at or above a second threshold.

The method may comprise determining the quantity of heat stored in the tank at least in part using a temperature probe. The method may comprise determining the quantity of heat stored in the tank at least in part using a temperature sensor array comprising a plurality of temperature sensors. The method may comprise determining the quantity of heat stored in the tank at least in part using a flow meter. The method may comprise determining the quantity of heat stored in the tank at least in part using temperature sensors at the inlet and outlet of the tank.

The method may further comprise determining additionally a length of time that would be required to raise the quantity of heat stored in the tank to the target maximum quantity of heat that the heating system is able to store in the tank. The method may further comprise only changing the power state of the heat pump when the length of time exceeds a minimum threshold. The method may further comprise only changing the power state of the heat pump when the surplus electricity generated by the photovoltaic system exceeds a minimum threshold.

The method may comprise determining the surplus electricity generated by the photovoltaic system as an electricity being exported to an external electricity grid and/or as a difference between an electricity generated by the photovoltaic system and a domestic electricity demand. The method may comprise determining the electricity being exported to an external electricity grid, the domestic electricity demand, and/or the electricity generated by the photovoltaic system by a current clamp. The method may comprise determining the electricity being exported to an external electricity grid, the domestic electricity demand, and/or the electricity generated by the photovoltaic system by a local utility meter.

The method may further comprise only changing the power state of the heat pump when a predicted surplus electricity generated by the photovoltaic system exceeds a minimum threshold.

The change in power state of the heat pump may be a binary change between an off state and an on state. The change in power state of the heat pump may be a modulation of the power level between a lower power operating level and a higher power operating level.

The method may further comprise receiving via a user interface a user-configured change in power state of the heat pump on the basis of external electricity prices.

The method may comprise reducing the power state of the heat pump if the surplus electricity generated by the photovoltaic system falls below a threshold.

The method may comprise maintaining the heat pump in the on state for at least a minimum period of time.

The method may comprise determining whether to provide heat to an upper part of the tank for topping up a smaller hot volume of water, or to provide heat to a lower part of the tank for gradually heating the whole tank; and actuating a means of diverting heat either to an upper part of the tank or to a lower part of the tank.

The method may be adapted for a heating system as aforementioned. The method may include actions as provided by an aforementioned controller.

According to another aspect there is provided a non-transitory medium storing computer-executable code that, when executed, performs the method as aforementioned.

According to another aspect there is provided a controller for a heating system, wherein the controller is configured to perform the method as aforementioned.

According to another aspect there is provided a computer program and a computer program product for carrying out any of the methods described herein and/or for embodying any of the apparatus features described herein. According to another aspect there is provided a non-transitory computer readable medium having stored thereon a program for carrying out any of the methods described herein and/or for embodying any of the apparatus features described herein. According to another aspect there is provided a computer program product comprising software code for carrying out any method as herein described. Features implemented in hardware may generally be implemented in software, and vice versa. Any reference to software and hardware features herein should be construed accordingly.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

As used herein, means plus function features may be expressed alternatively in terms of their corresponding structure, such as a suitably programmed processor and associated memory.

### BRIEF DESCRIPTION OF THE DRAWINGS

These and other aspects of the present invention will become apparent from the following exemplary embodiments that are described with reference to the following figures in which:

FIG. 1 is a schematic of a first heating system;

FIG. 2 is a schematic of a second heating system;

FIG. 3 is a schematic of a third heating system;

FIG. 4 is a schematic of a fourth heating system;

FIG. 5 is a schematic of a fifth heating system;

FIG. 6 is a schematic of a sixth heating system;

FIG. 7 is set of graphs showing simulation results for heat pump use without use of surplus electricity from a photovoltaic (PV) system;

FIG. 8 is set of graphs showing simulation results for heat pump use with use of surplus electricity from a PV system;

FIG. 9 is set of graphs showing simulation results for heat pump use with use of surplus electricity from a PV system;

FIG. 10 is set of graphs showing simulation results for the simulation of FIG. 7 extended to a year; and

FIG. 11 is set of graphs showing simulation results for the simulation of FIG. 8 extended to a year.

### DETAILED DESCRIPTION OF SPECIFIC EMBODIMENTS

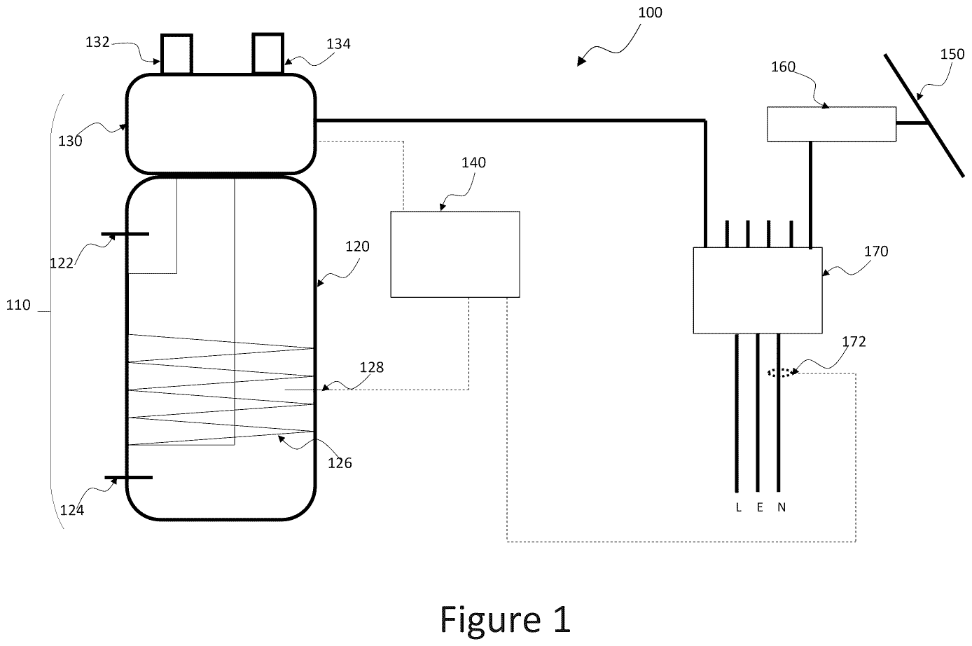

FIG. 1 shows a schematic of a first heating system 100 that includes a hot water tank 120 and a heat pump 130. The hot water tank comprises a hot water outlet 122, a cold water inlet 124 and a temperature probe 128. The heat pump in the illustrated example comprises an air intake 132 and air outlet 134. To transfer heat collected by the heat pump 130 to or from the hot water tank 120 heat exchanger pipes 126 of the heat pump 130 are at or in the hot water tank 120 so as. The heat exchanger pipes 126 may be positioned outside the water tank, such as around the external wall of the water tank, and/or may have at least a portion inside the water tank. For example the heat exchanger pipes 126 may comprise a coil portion inside the water tank. The heat pump 130 and tank 120 are provided as a single unit 110 in the illustrated examples, but it should be appreciated that the heat pump 130 and tank 120 may alternatively be provided as separate units.

The heat pump is communicatively coupled to the controller 140.

The heating system further comprises a solar PV system 150, which comprises at least one solar PV panel. The solar PV system is connected to an inverter 160. The inverter is connected to a power distribution board 170, which itself connects to further circuits. A current clamp 172 is configured to monitor power transfer between the power distribution board and an external electricity grid, and is communicatively coupled to the controller. The illustrated current clamp 172 monitors current flowing on a neutral wire (marked ‘N’ in the figures) from the power distribution board 170 to the external electricity grid.

In operation, the solar PV system generates electricity from incident sunlight. This is generated as DC electricity. Since most applications require AC current, the output is then fed into the inverter, which converts DC current into an alternating current. After conversion, the power is fed into the power distribution board 170. When the heating system is implemented in a home, this distributes the power between the circuits relating to various domestic power uses. For example, the electricity may be directed towards cooking appliances, laptops, and other such devices. The power may also be directed towards domestic energy stores, such as electric batteries. The power distribution board may also receive power from further energy sources. These may be alternative domestic sources of electricity generation, such as wind turbines, or may be external sources of electricity, such as an electricity grid. The power distribution board is also coupled to the heat pump, such that the electricity from the power distribution board may power the heat pump.

In one example, the heat pump of FIG. 1 operates using a refrigerant. The refrigerant may be for example a compressible fluid or a phase-change material. The refrigerant is pumped through the heat pump: in general terms through a compressor, a heat source, an expander, and a heat drain (the heat exchanger pipes 126 in the illustrated examples). Whether as a result of phase change or as a result of compression in the refrigerant lines, the refrigerant releases heat to the surroundings when in the heat exchanger pipes around or in the hot water tank 120, and absorbs heat from the surroundings. Air intake 132 and air outlet 134 may allow air from the environment to provide a heat source, which results in air cooled from thermal contact with the refrigerant being released into the surroundings and replaced by warmer air. Alternatively and/or additionally, the heat pump may draw heat from the environment using a heat transfer line, or other arrangements as are known in the art.

The hot water tank 120 is heated by the refrigerant, which heats the water within the tank. Hot water outlet allows hot water to be released into further pipes (not illustrated), which may connect with a domestic heating system or a domestic hot water supply of potable water. For example, the water from the hot water tank may flow into a central heating system, a shower, bath, or the like, depending on whether the tank holds potable water or water with additives for heat storing purposes. In one example the hot water tank holds pressurised potable water for providing to a user. In such a tank heat exchangers can enable transfer of heat from water in the tank to a central heating system. In another example the hot water tank holds unpressurised non-potable water for storing heat. The non-potable water may be provided to a central heating system and heat exchangers can enable transfer of heat from water in the tank to a pressurised circuit of potable water. In some examples the water in the tank is separate from a circuit of water of a central heating system, in which case heat exchangers can enable transfer of heat from water in the tank to a central heating system.

The controller 140 receives information on the temperature of the hot water tank from temperature probe 128. Temperature probe 128 may be a temperature sensor penetrating into the water of the hot water tank. The controller also receives information from the current clamp on the transfer of electricity between the power distribution board and an external electricity grid. For example, when the PV system is producing an excess of electricity, the power distribution board may transfer electricity to the external electricity grid. Similarly, when the PV system is not producing sufficient electricity to meet energy demands on the power distribution board, the power distribution board may receive electricity from the external electricity grid. The controller may receive via the current clamp an indication of whether electricity is transferred to or from the external electricity grid, as well as an indication of the quantity of power being transferred.

The controller is coupled to the heat pump 130. The controller determines whether there is a surplus of electricity generation from the PV unit. The controller also receives the temperature of the hot water tank, and determines the difference between this actual temperature and a target temperature of the hot water tank. This target temperature may be a maximum (safe) operating temperature of the hot water tank. The difference between the actual and target temperatures is a heat storge capacity that the hot water tank has to store excess energy in the form of heat. This may be useful even if no immediate heat demand exists, as heat can be stored efficiently for later use in heating. The controller may switch the heat pump on based on determining that the hot water tank has capacity to store further energy (in the form of heat), and on determining that there is a surplus of electricity generation from the PV unit. The controller may instead base a decision to switch on the heat pump on determining that the water tank has a capacity to absorb further energy above a threshold capacity value, and on determining that there is a surplus of electricity generation from the PV unit.

The tank is typically designed or intended to hold a target maximum quantity of heat, also referred to as a maximum heat storage capacity or a maximum quantity of heat that the heating system is able to store (safely) in the tank. This target maximum quantity of heat depends on factors such as a tank volume, a maximum temperature for safe operation of the tank, absence or presence of provisions for reducing dead volume that cannot be heated effectively, pressure, auxiliary features immersed in the tank, additives, and other factors.

In embodiments, once the heat pump is switched on, it is kept on for at least a minimum threshold period of time, even if the surplus electricity decreases and/or even if there ceases to be a surplus of electricity.

Advantageously, the use of a threshold capacity value before the heat pump is switched on, and/or the use of a minimum threshold period of time during which the heat pump is kept on, allows the controller to avoid excessive cycling of the heat pump (wherein the heat pump is switched on and off in quick succession), resulting in in improved energy efficiency, and reduced ageing of the heat pump.

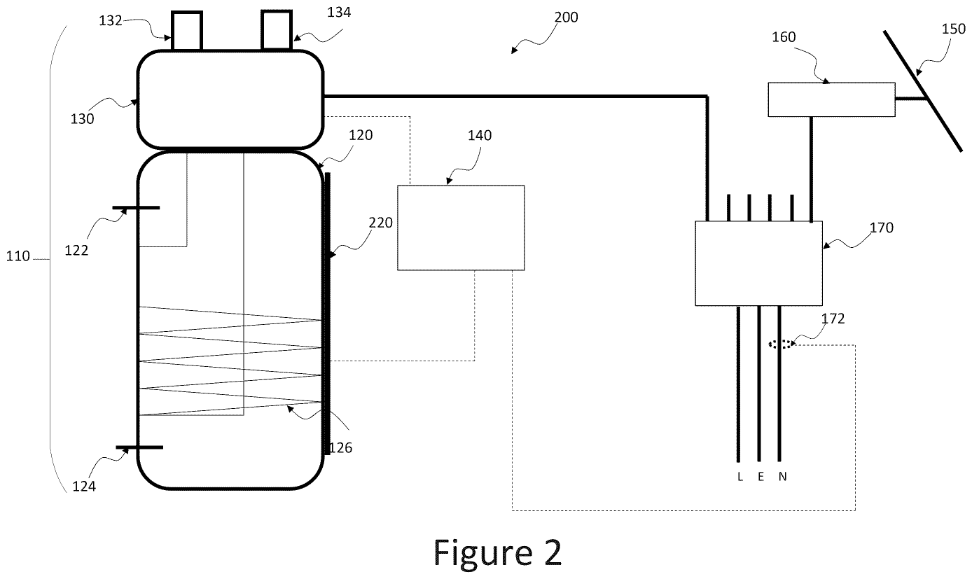

FIG. 2 shows a schematic of a second heating system, which is a variant of the system illustrated in FIG. 1. The heating system 200 comprises a state of charge sensor 220, which comprises a series of temperature sensors along the wall of the hot water tank 120, which provide information to the controller 140. The controller uses the temperature information from the state of charge sensor to determine the hot water tank's capacity to store further energy.

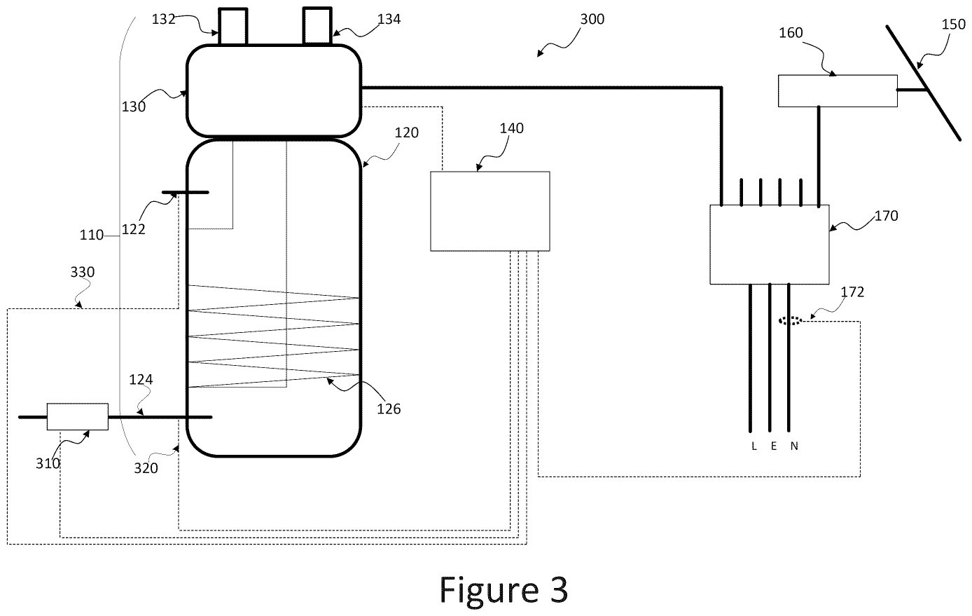

FIG. 3 shows a schematic of a third heating system, which is an additional variant of the system illustrated in FIG. 1. The heating system 300 comprises a flow meter 310, inlet temperature measurement probe 320, and outlet temperature measurement probe 330. The flow meter, the inlet temperature measurement probe, and the outlet temperature measurement probe, all provide information to the controller 140. The controller can use the flow values and the temperature measurements to infer a temperature distribution from a model of temperature distribution in the tank, and therefore predict the hot water tank's capacity to store further energy.

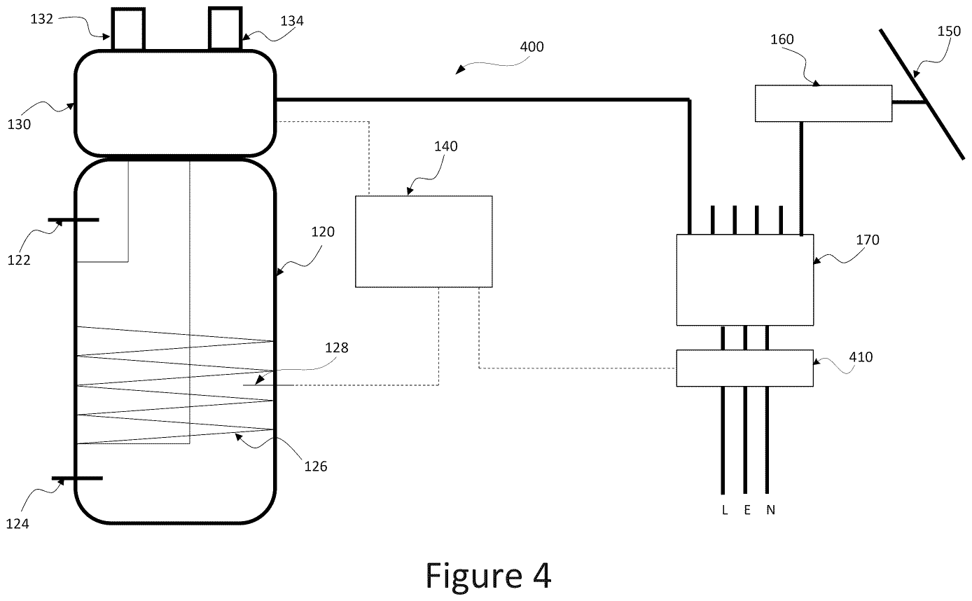

FIG. 4 shows a schematic of a fourth heating system, which is a variant of the system illustrated in FIG. 1. The system 400 of FIG. 4 comprises a smart meter 410 and the current clamp is omitted. The smart meter 410 can provide data quantifying export of surplus energy from the PV unit to the external electricity grid.

The controller uses the information from the smart meter to determine the surplus electricity generation. In embodiments, the surplus electricity may be the difference between the electricity generated by the solar PV system and the household energy use as determined by the smart meter. In embodiments, the surplus electricity may be the difference between the electricity generated by the solar PV system and the projected household energy use as determined by the smart meter.

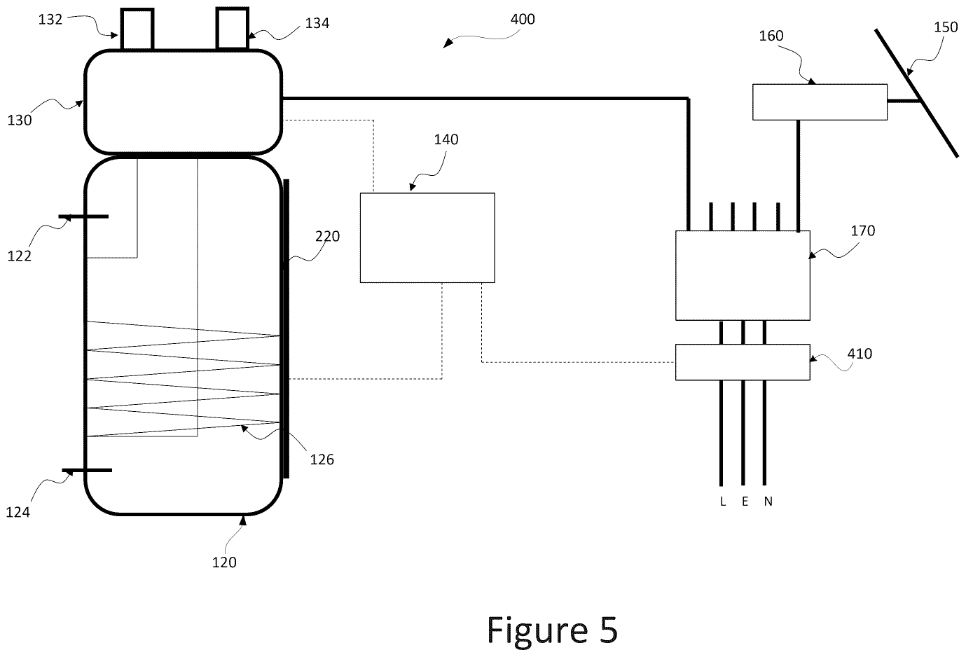

FIG. 5 shows a variant of the systems illustrated in FIGS. 2 and 4. The system 400 combines the state of charge sensor 220 with a smart meter 410 as described in relation to FIG. 4.

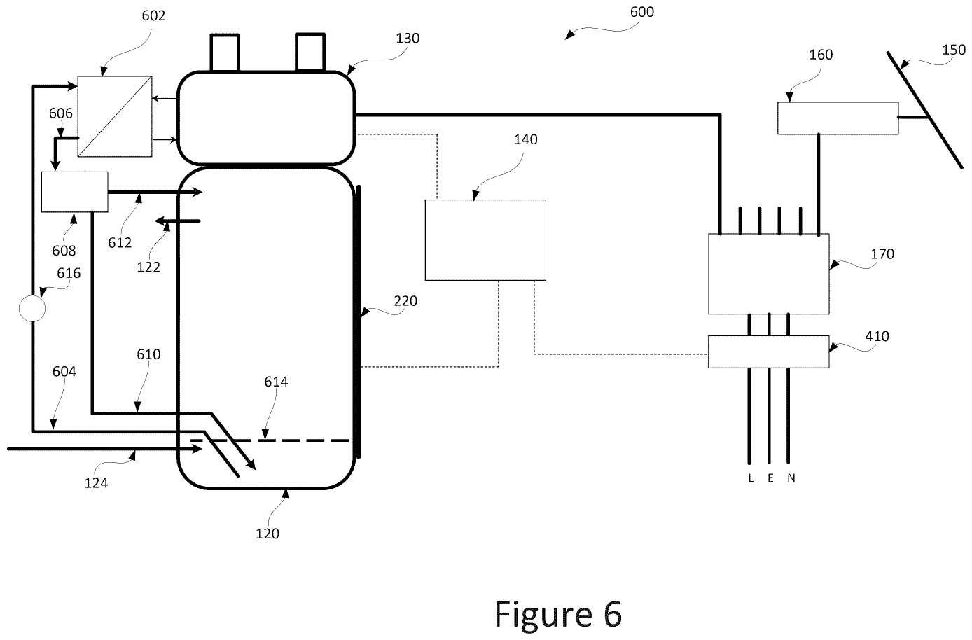

FIG. 6 shows another variant of the systems illustrated in FIGS. 1 to 5. The system 600 combines the state of charge sensor 220 with a smart meter 410 as described in relation to FIG. 5, but an alternative means for providing heat from the heat pump to the tank is provided. Instead of a heat exchanger 126 arranged at the tank, an external heat exchanger 602 is provided. A suitable pump 616 pumps water via a draw conduit 604 from the bottom of the tank to the external heat exchanger 602, where the water receives heat from the heat pump 130. The heated water is then returned to the tank 120. In the illustrated example the return conduit 606 includes a lower return branch 610 arranged to return water to a lower part of the tank and an upper return branch 612 arranged to return water to an upper part of the tank. A diverter valve 608 is provided in the return conduit 606 to divert water back to the tank either via the lower return branch 610 or the upper return branch 612. This can permit more nuanced control of where heat is provided to the tank, for example for rapid but less efficient heating of a smaller quantity of water at the top of the tank for immediate use, or for more gradual and efficient heating of a larger volume of water in the tank. The controller can determine whether to provide heat to an upper part of the tank for topping up a smaller hot volume of water, or to provide heat to a lower part of the tank for gradually heating the whole tank. The controller can make this determination based on e.g. a sensed tank temperature and a temperature set-point level, or on a temperature distribution in the tank.

A baffle 614 is provided to enclose a portion of water near the bottom of the tank. The baffle is arranged above the cold water inlet 124, above the inlet to the draw conduit 604 and above the outlet from the lower return branch 610. This can permit fluid flows that can occur at these in-and outlets to be contained in that portion of the tank, and avoid or reduce disruption of thermal stratification in the rest of the tank.

The illustrated external heat exchanger is a plate heat exchanger, but other heat exchangers may perform the same function, such as a shell-and-tube heat exchanger or another two-forced-flows heat exchanger.

It will be appreciated that the features of FIGS. 1 to 6 may be combined interchangeably. For example a variant may include the flow meter 310, inlet temperature measurement probe 320, and outlet temperature measurement probe 330 as described in relation to FIG. 3 and a smart meter 410 as described in relation to FIG. 4.

The controller serves to optimise energy use in the system. While a heat pump can achieve high efficiency in converting electrical energy to thermal energy—e.g. comparing favourably to an electrical immersion heating element—a heat pump can suffer inefficiency and mechanical cycling stresses with some operation patterns, such as frequent brief switching on. The controller serves to optimise energy use in the system by switching on the heat pump to convert surplus electric energy from the PV unit while avoiding use of the heat pump under some circumstances where it would be inefficient or undesirable to do so, and in particular to avoid short cycling of the heat pump. Solar energy can be particularly intermittent and optimisation particularly beneficial.

The controller serves to make the most of any available surplus solar energy by generating useable heat within the hot water tank by turning on or off or modulating the output of the heat pump. The challenges include the avoidance of frequent start-stop or ramp-up or ramp down of the heat pump; and accommodation of the warm-up efficiency penalty associated with a heat-pump which erodes the value of turning the system on or ramping up to a higher power level if the duration of steady state operation is too short relative to the energy invested in initially warming the system up.

The controller determines whether or not to turn on the heat-pump where there is surplus solar energy in response to the available heat storage capacity to absorb further energy available at the hot water tank.

In an example the controller receives data quantifying or permitting the controller to determine:
Net PV, a power export (e.g. from a smart meter or a current clamp); and
SOCIn, an available ‘state of charge’ or quantity of heat currently stored at the tank (e.g. from a temperature sensor, a temperature sensor array, and/or a flow meter), relative to a target maximum quantity of heat that the tank is able to store safely.

The controller has a number of threshold parameters defined:
PowerThresh, a minimum power export level
SOCThresh, a minimum ‘state of charge’ or heat storage capacity at the tank

Based on these values, an example logic for the control strategy is: wherever there is net power export detected (netPV), and where that net power export is greater than a threshold level (PowerThresh), then the heat pump will turn on (HeaterON state) if the state of charge level (SOCIn) is less than a threshold level (SOCThresh). The controller can cause the heat pump to turn off if the net power export drops below a threshold level such as 0 (when no surplus solar electricity is available) or if the state of charge level (SOCIn) exceeds a threshold level (e.g. a maximum quantity of water at a certain temperature, or a maximum temperature in a specific location in the tank).

In an example PowerThresh might be in the order of 100 watts for a small integrated heat pump head unit which consumes up to 400 W during operation. The state of charge threshold may be 90% implying a minimum heat storage capacity (to absorb further energy) at the tank of 10% of the maximum heat capacity of the tank. In this example, the controller causes the heat pump to turn on whenever there is at least 100 watts of export and an available heat storage capacity (to absorb further energy) of 10% of the maximum heat capacity for the tank to be heated until it is unable to accommodate any more thermal energy. This ensures that on turning the heat pump on, it will run for at least the amount of time it takes to fully charge the tank which might mean 20 minutes if the tank has 10% of headroom available.

In some examples the controller can cause the heat pump to turn off if the export PV drops below a further threshold value. This control strategy can lead to additional mechanical cycling during periods of intermittent solar energy.

In some examples the controller can factor run time of the heat pump into the control strategy, causing the heat-pump to run for at least a minimum length of time, which may be set depending on the selected minimum available heat storage capacity of the tank.

The minimum run-time could be further calibrated by additional information such as the time of year and/or an external weather forecast alongside any scheduling limits which set the maximum allowable state of charge within the tank which may be less than the tank's peak capacity.

Selecting the minimum power export level, minimum available heat storage capacity (to absorb further energy) of the tank and a minimum heat pump run time is balanced to trade-off between:
The amount of solar energy that is usefully turned into free hot water
The amount of grid energy that is drawn when the minimum run time requirement is not met by the PV energy available, with the use of grid energy possibly being unnecessary or more expensive than the solar energy
The number of times that the heat pump is turned on or off or modulated up and down in power level in the case of an inverter driven heat pump head unit

It is noted that there is a trade-off between heat-pump health and the flexibility of the system. A high threshold capacity value or high minimum threshold period of time reduce the flexibility of the system, as the heat pump will not be switched on if there is a surplus but the capacity is not reached, so will not respond to periods of surplus power, and a high minimum threshold period of time means that the heat pump will not be switched off if there is a deficit of power, meaning that electricity may be drawn from the grid.

To determine the optimum balance between these factors, modelling may be carried out using solar generation data, energy demand for a home, and hot water consumption for a home. Modelling may incorporate features of the fluid dynamics within the water tank, such as thermal stratification, wherein hot water rises to the top of the water tank resulting in a temperature profile varying with height within the water tank. Such a model may be constructed using a multi-node one dimensional simulation coupled to a mixing algorithm. The model may also take into accound threshold temperatures associated with user comfort.

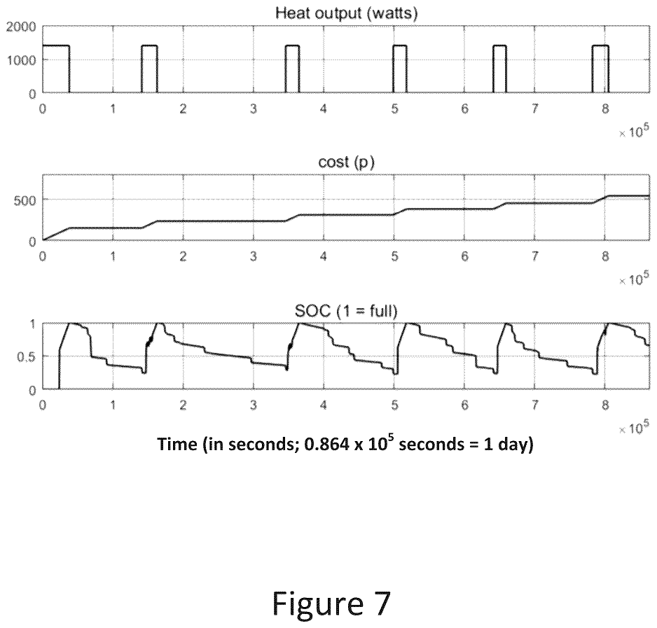

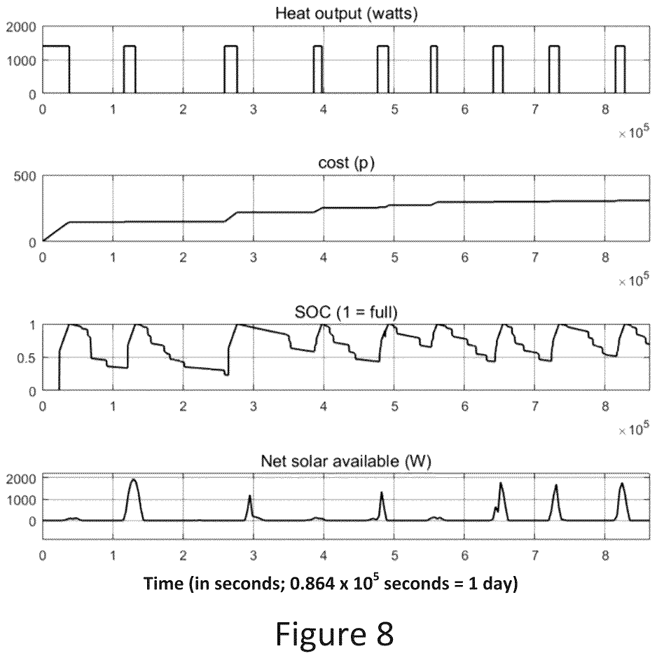

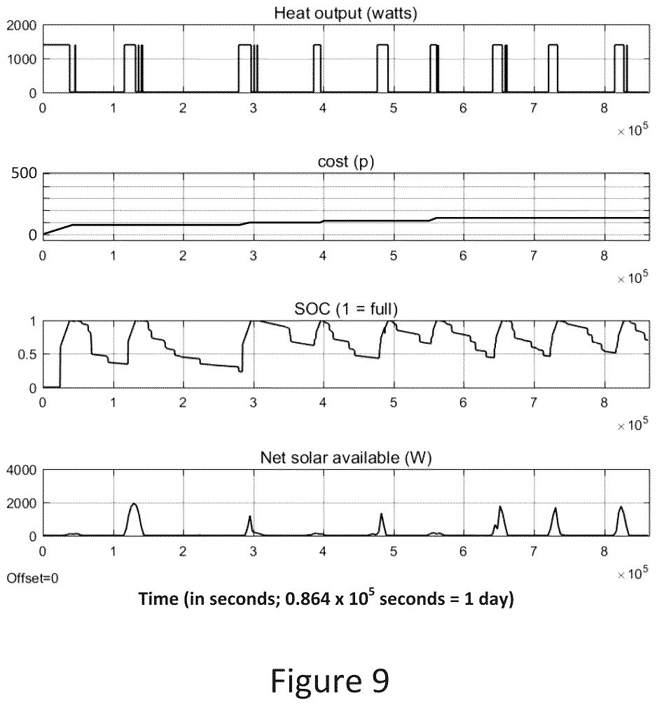

FIG. 7 shows simulation results for heat pump use without use of the PV system to store energy. FIG. 8 shows simulation results for heat pump use with use of the PV system to store energy. The simulation is for PowerThresh=100 watts for a small integrated heat pump head unit which consumes up to 400 W during operation; the state of charge threshold is 90%, i.e. the minimum heat storage capacity (to absorb further energy) at the tank of 10%. A minimum run time for the heat pump is set such that when surplus solar energy drops away grid electricity is drawn instead for the rest of the minimum run time. FIG. 9 shows simulation results with different control thresholds: here PowerThresh=100 watts again, but the state of charge threshold is 99%, i.e. a minimum heat storage capacity (to absorb further energy) of 1%. With this regime even a small capacity to absorb heat at the tank causes the heat pump to be switched on. The time span for each of these three simulations is 10 days (8.64×10⁵ seconds). In the figures the top trace shows heat output by the heat pump to the hot water tank (in watts); the second trace shows cost (in pence GBP) of energy drawn from the external grid based on a particular energy tariff; the third trace shows state of charge of the tank; and in FIGS. 8 and 9 the fourth trace shows surplus solar energy (same for both simulations).

Below is a table showing numerical results for the simulations shown in FIGS. 7 and 8.

With solar PV (FIG. 8)

| | |
|---|---|
| Total energy | 16.62 |
| Grid | 8.76 |
| Solar (free) | 7.86 |
| Number of compressor cycles | 9 |
| Cost | £3.70 |

With no solar PV (FIG. 7)

| | |
|---|---|
| Total energy | 15.42 |
| Grid | 15.42 |
| Solar (free) | 0 |
| Number of compressor cycles | 6 |
| Cost | £5.40 |
| Monetary saving over 10 days | £1.70 |

As can be seen, comparing simulation results of FIGS. 7 and 8, when using the heat pump and tank to store surplus solar PV energy the heat pump undergoes more on-off cycles (9 instead of 6 cycles) than when no attempt is made to use surplus PV energy.

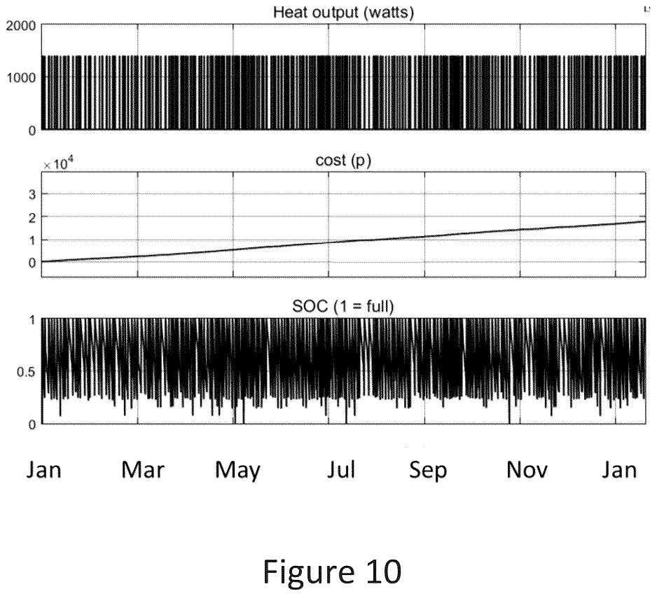

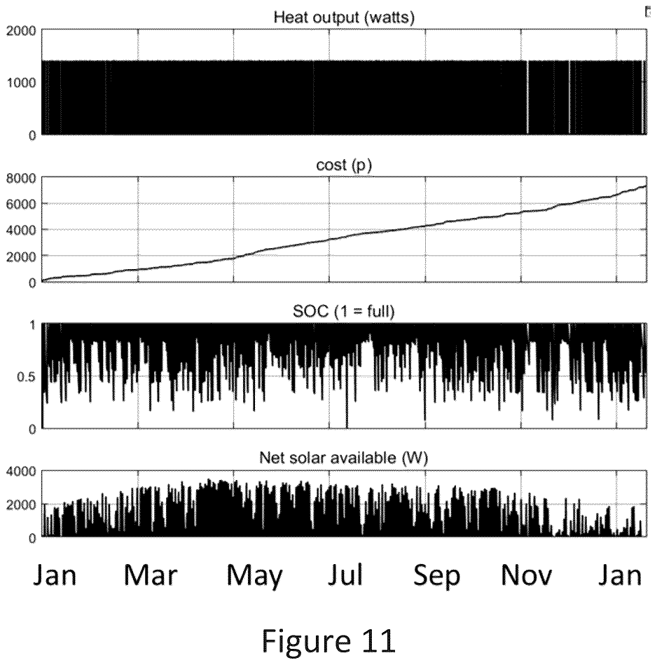

However, the system with solar PV significantly reduces the power that must be drawn from the grid, at a reduced overall cost to the user. In the system with solar PV some grid energy was imported due to the compressor continuing to run when surplus solar energy dropped away. Comparing simulation results of FIG. 8 (state of charge threshold 90%) and 9 (state of charge threshold is 99%), when the state of charge threshold is higher the controller causes the heat pump to switch on more often: according to the simulation results of FIG. 9 the heat pump underwent 19 on-off cycles, compared to 9 cycles in FIG. 8. The cost saving was 30% since there was no inadvertent use of grid energy during responses to solar PV surpluses due to the fact that the system was able to shut down whenever there was no surplus solar PV available. In this example, the 5% improvement in operating cost would be offset by the accelerated degradation of the heat pump and so the control strategy of FIG. 8 would be more favourable. FIGS. 10 and 11 show simulation results for the same simulations as in FIGS. 7 and 8 respectively, when left to run for a full year. The numerical results are summarised in the table below.

Grid Electricity only (full year)

| | |
|---|---|
| Total energy | 506.5 |
| Grid | 506.5 |
| Solar (free) | 0 |
| Number of compressor cycles | 221 |
| Cost | £177.28 |

With solar PV (full year)

| | |
|---|---|
| Total energy | 573.5 |
| Grid | 208.2 |
| Solar (free) | 365.3 |
| Number of compressor cycles | 553 |
| Cost | £72.87 |

The table shows that the solar PV system drastically reduces the requirement for electricity from a grid and with that reducing the cost to the user, at the cost of doubling the number of compressor cycles.

Further refinement of the control strategy (such as altering the minimum time thresholds for which the heat pump is switched on, and/or altering the threshold capacity of the tank to store extra energy in the form of heat) may be used to achieve greater benefits. For example, the control strategy could be refined to factor in the time of year and time of day into parameters. In one example, the control strategy could be refined based on the knowledge of the time of day or time of year suggesting a likely duration of surplus electricity generation. In one example, the control strategy could be refined to avoid switching on the heat pump when there is a surplus of electricity but the time is within a threshold period before sunset.

In an example, the control strategy could be refined to integrate weather forecast data.

In an example, the control strategy could be refined to increase the quantity of heat stored in the tank in advance of night time, and/or to reduce the quantity of heat stored in the heat tank in advance of sunny days.

In an example, the control strategy could be refined to factor in information on the on/off cycle behaviour of the heat pump, such as life information provided by a manufacturer. In an example, the control strategy could be refined to factor in a start-up penalty associated with the heat pump.

Various other modifications will be apparent to those skilled in the art.

The controller is illustrated in the examples as solely focused on the control of the heat-pump operating with a hot water tank for the purposes of providing domestic hot water and/or space heating. It should be understood that the controller may control or be part of another controller having further control of a broader home energy management system encompassing additional energy storage assets such as an electric vehicle battery via control of a third party EV charger or a fixed home battery within the home.

In the illustrated examples a unit integrates both heat pump and hot water tank. It should be understood that the system could also be adapted for a wide variety of heat pumps and hot water tanks, including for example an external outboard monobloc air source heat pump, a ground source heat pump or any other indirect energy source to the hot water tank.

While these examples mostly consider determination of domestic electricity use using a smart meter, it should also be recognised that such an invention could determine domestic electricity use using a local utility meter, using information gathered from devices using the cloud, and/or using a model.

In embodiments, the controller may also receive information regarding an external price of electricity. The controller may determine not to switch on the heat pump during times at which the price of electricity is high, even if there is a surplus of electricity, to allow electricity to be sold back to the grid, and/or to avoid the risk of running the heat pump on electricity from the grid in the case that the surplus of electricity generation ceases before the heat pump has been run for a minimum threshold period of time. Additionally, the controller may determine to switch on the heat pump even when there is no surplus of electricity, and/or when the surplus of electricity is below a threshold, during times at which the price of electricity is low. Advantageously, this may allow the heating system to buffer changes in demand for electricity across a centralised system such as an electricity grid.

In embodiments, the controller may further take user input. The user input may allow a user to switch on a heat pump even when the electricity conditions would not otherwise dictate that the controller switch on the heat pump. The user input may also allow a user to schedule the heat pump to switch on at certain times of the day, and/or when the price of electricity is at certain values.

In embodiments, the controller is not limited to on/off determination, and may also increase or decrease the power state of a heat pump, such as changing a heat pump power state from a low power state to a medium or a high power state. In embodiments, the power states may be on a continuous spectrum. In embodiments, the solar PV system may not be connected to a PV diverter. Advantageously, this reduces the hardware requirements of the solar PV system.

In many of the examples a means of determining a temperature distribution in the tank is included. A means of determining a temperature distribution in the tank can permit accurate determination of a quantity of heat stored in the tank. A means of determining a temperature distribution in the tank may include as few as one temperature sensor and infer a temperature distribution from a model of temperature distribution in the tank.

Inferring a temperature distribution from a model of temperature in a tank can be improved with measurements such as a flow rate measurement of fluid into and/or out of the tank and temperature data from outside the tank, such as at a cold inlet and at a hot inlet. Other means of determining a temperature distribution of water in the tank may include thermal imaging or density sensing or other suitable techniques.

Many of the illustrations show examples of tanks in the form of water cylinders. Water cylinders are typically unvented tanks for containing mains pressurised water. A pressurised tank can distribute hot water throughout a building without needing any pumps. A water cylinder is a tank in the form of a cylinder with domed ends. This form is favourable for stress distribution and particularly well suited for a tank for containing pressurised water. The tank may however be in another form. The tank may be a vented tank for containing water at ambient pressure. The water contained in the tank may include additives.

Many of the illustrations show examples where heat is provided to a certain region of the tank, or to two distinct regions of the tank. In general, one, two or more heat transfer zones may be accommodated. For example, if three heat exchange coils are included at the upper, central and lower portion of the tank those portions may be selectively heated or heat drawn (similarly if three draw branches and three return branches are included with the external heat exchanger arrangement). This may be appropriate for particularly large tanks, for example. The tank may include further heat exchangers, inside or outside the tank, for drawing or providing heat at different locations in the tank.

Many of the illustrations show examples of heat transfer coils arranged inside the tank. Coils may alternatively be arranged outside the tank, e.g. at the tank wall. Some of the examples show a plate heat exchanger arranged outside the tank. A plate heat exchanger (or other two-forced-flows heat exchanger) may alternatively be arranged inside the tank, e.g. with a submersible pump to drive flow, or with a conduit section outside the tank to accommodate a pump outside the tank. A finned passive flow heat exchanger may be provided inside the tank for heat exchange.

Where the terms ‘above’ and ‘below’, ‘upper’ and ‘lower’ are used herein, these are meant with the tank in such orientation as it is intended to be installed for use.

Where the upper portion of the tank is referred to herein (e.g. for providing heated water to), it should be appreciated that this may include near the top of the tank, a top portion of the tank, a top half, third or quarter of the tank (by volume or by height), with the tank in such orientation as it is intended to be installed for use. Where a lower portion of the tank is referred to (e.g. for providing heat to, or for pumping water to be heated from), it should be appreciated that this may include near the bottom of the tank, a bottom portion of the tank, a part of the tank that is not an upper portion of the tank, or a bottom half, third or quarter of the tank (by volume or by height), with the tank in such orientation as it is intended to be installed for use.

An upper feature as referred to herein is preferably above a lower feature in the tank, with the tank in such orientation as it is intended to be installed for use. An upper feature is preferably in an upper portion of the tank. A lower feature as referred to herein is preferably below an upper feature of the tank, with the tank in such orientation as it is intended to be installed for use. A lower feature is preferably in a lower portion of the tank.

It will be understood that the present invention has been described above purely by way of example, and modifications of detail can be made within the scope of the invention.

Reference numerals appearing in the claims are by way of illustration only and shall have no limiting effect on the scope of the claims.

The term ‘comprising’ as used in this specification and claims preferably means ‘consisting at least in part of’.

1. A heating system comprising:
a tank for holding fluid;
a photovoltaic system;
a heat pump arranged to provide heat to the tank; and
a controller configured to:
determine a quantity of heat stored in the tank relative to a target maximum quantity of heat that the heating system is adapted to store in the tank;
determine a level of solar power surplus electricity generated by the photovoltaic system; and
on the basis of the quantity of heat stored in the tank relative to the target maximum quantity of heat, and the level of solar power surplus electricity, changing a power state of the heat pump.

2. A heating system according to claim 1, wherein the controller is configured to switch on the heat pump on the condition of the quantity of heat stored in the tank relative to the target maximum quantity of heat being at or below a first threshold.

3. A heating system according to claim 1 or 2, wherein the controller is configured to switch on the heat pump on the condition of the level of solar power surplus electricity being at or above a second threshold.

4. A heating system according to any preceding claim, wherein the quantity of heat stored in the tank is determined at least in part using a temperature probe.

5. A heating system according to any preceding claim, wherein the quantity of heat stored in the tank is determined at least in part using a temperature sensor array comprising a plurality of temperature sensors.

6. A heating system according to any preceding claim, wherein the quantity of heat stored in the tank is determined at least in part using a flow meter.

7. A heating system according to any preceding claim, wherein the quantity of heat stored in the tank is determined at least in part using temperature sensors at the inlet and outlet of the tank.

8. A heating system according to any preceding claim, wherein the controller is further configured to determine additionally a length of time that would be required to raise the quantity of heat stored in the tank to the target maximum quantity of heat that the heating system is able to store in the tank.

9. A heating system according to claim 8, wherein the controller is further configured only to change the power state of the heat pump when the length of time exceeds a minimum threshold.

10. A heating system according to any preceding claim, wherein the controller is further configured only to change the power state of the heat pump when the surplus electricity generated by the photovoltaic system exceeds a minimum threshold.

11. A heating system according to any preceding claim, wherein the controller determines the surplus electricity generated by the photovoltaic system as an electricity being exported to an external electricity grid and/or as a difference between an electricity generated by the photovoltaic system and a domestic electricity demand.

12. A heating system according to claim 11, wherein the electricity being exported to an external electricity grid, the domestic electricity demand, and/or the electricity generated by the photovoltaic system is determined by a current clamp.

13. A heating system according to claim 11, wherein the electricity being exported to an external electricity grid, the domestic electricity demand, and/or the electricity generated by the photovoltaic system is determined by a local utility meter.

14. A heating system according to any preceding claim, wherein the controller is further configured only to change the power state of the heat pump when a predicted surplus electricity generated by the photovoltaic system exceeds a minimum threshold.

15. A heating system according to any preceding claim, wherein the change in power state of the heat pump is a binary change between an off state and an on state.

16. A heating system according to any of claims 1-14, wherein the change in power state of the heat pump modulates the power level between a lower power operating level and a higher power operating level.

17. A heating system according to any preceding claim, further comprising a user interface.

18. A heating system according to claim 17, wherein the user interface allows a user to configure changes in power state of the heat pump on the basis of external electricity prices.

19. A heating system according to any preceding claim, wherein one or more refrigerant coils and/or plate heat exchangers and/or coil heat exchangers are arranged to provide heat from the heat pump to the tank.

20. A heating system according to any preceding claim, wherein the controller is configured to reduce the power state of the heat pump if the surplus electricity generated by the photovoltaic system falls below a threshold.

21. A heating system according to any preceding claim, wherein the controller is configured to maintain the heat pump in the on state for at least a minimum period of time.

22. A heating system according to any preceding claim, wherein the controller is configured to determine whether to provide heat to an upper part of the tank for topping up a smaller hot volume of water, or to provide heat to a lower part of the tank for gradually heating the whole tank; and to actuate a means of diverting heat either to an upper part of the tank or to a lower part of the tank.

23. A method of controlling a heating system, the method comprising:
determining a quantity of heat stored in a tank relative to a target maximum quantity of heat that the heating system is able to store in the tank;
determining a level of solar power surplus electricity generated by a photovoltaic system; and
on the basis of the quantity of heat stored in the tank relative to the target maximum quantity of heat that the heating system is able to store in the tank and the level of solar power surplus electricity, changing a power state of the heat pump.

24. A method according to claim 23, comprising switching on the heat pump on the condition of the quantity of heat stored in the tank relative to the target maximum quantity of heat being at or below a first threshold.

25. A method according to claim 23 or 24, comprising switching on the heat pump on the condition of the level of solar power surplus electricity being at or above a second threshold.

26. A method according to any one of claims 23 to 25, comprising determining the quantity of heat stored in the tank at least in part using a temperature probe.

27. A method according to any one of claims 23 to 26, comprising determining the quantity of heat stored in the tank at least in part using a temperature sensor array comprising a plurality of temperature sensors.

28. A method according to any one of claims 23 to 27, comprising determining the quantity of heat stored in the tank at least in part using a flow meter.

29. A method according to any one of claims 23 to 28, comprising determining the quantity of heat stored in the tank at least in part using temperature sensors at the inlet and outlet of the tank.

30. A method according to any one of claims 23 to 29, further comprising determining additionally a length of time that would be required to raise the quantity of heat stored in the tank to the target maximum quantity of heat that the heating system is able to store in the tank.

31. A method according to claim 30, further comprising only changing the power state of the heat pump when the length of time exceeds a minimum threshold.

32. A method according to any one of claims 23 to 31, further comprising only changing the power state of the heat pump when the surplus electricity generated by the photovoltaic system exceeds a minimum threshold.

33. A method according to any one of claims 23 to 32, comprising determining the surplus electricity generated by the photovoltaic system as an electricity being exported to an external electricity grid and/or as a difference between an electricity generated by the photovoltaic system and a domestic electricity demand.

34. A method according to claim 33, comprising determining the electricity being exported to an external electricity grid, the domestic electricity demand, and/or the electricity generated by the photovoltaic system by a current clamp.

35. A method according to claim 33, comprising determining the electricity being exported to an external electricity grid, the domestic electricity demand, and/or the electricity generated by the photovoltaic system by a local utility meter.

36. A method according to any one of claims 23 to 35, further comprising only changing the power state of the heat pump when a predicted surplus electricity generated by the photovoltaic system exceeds a minimum threshold.

37. A method according to any one of claims 23 to 36, wherein the change in power state of the heat pump is a binary change between an off state and an on state.

38. A method according to any one of claims 23 to 36, wherein the change in power state of the heat pump is a modulation of the power level between a lower power operating level and a higher power operating level.

39. A method according to any one of claims 23 to 38, further comprising receiving via a user interface a user-configured change in power state of the heat pump on the basis of external electricity prices.

40. A method according to any one of claims 23 to 39, comprising reducing the power state of the heat pump if the surplus electricity generated by the photovoltaic system falls below a threshold.

41. A method according to any one of claims 23 to 40, comprising maintaining the heat pump in the on state for at least a minimum period of time.

42. A method according to any one of claims 23 to 41, comprising determining whether to provide heat to an upper part of the tank for topping up a smaller hot volume of water, or to provide heat to a lower part of the tank for gradually heating the whole tank; and actuating a means of diverting heat either to an upper part of the tank or to a lower part of the tank.

43. A non-transitory medium storing computer-executable code that, when executed, performs the method of any one of claim 23 to 42.

44. A controller for a heating system, wherein the controller is configured to perform the method of claim 43.
